(19) United States
(12) Patent Application Publication
(10) Pub. No.: US 2021/0103156 A1
(43) Pub. Date: Apr. 8, 2021

(54) OPTICAL ARRANGEMENT AND LASER SYSTEM

(71) Applicant: TRUMPF Laser- und Systemtechnik GmbH, Ditzingen (DE)

(72) Inventors: Torsten Beck, Stuttgart (DE); Daniel Flamm, Stuttgart (DE); Andreas Heimes, Renningen (DE); Julian Hellstern, Rottweil (DE); Christian Lingel, Stuttgart (DE); Felix Marschall, Leinfelden-Echterdingen (DE); Silke Thierfelder, Ditzingen (DE); Christoph Tillkorn, Villingendorf (DE)

(21) Appl. No.: 17/123,139

(22) Filed: Dec. 16, 2020

Related U.S. Application Data
(63) Continuation of application No. PCT/EP2019/064582, filed on Jun. 5, 2019.

(30) Foreign Application Priority Data
Jun. 22, 2018 (DE) 10 2018 115 102.0

(51) Int. Cl. G02B 27/10; G02B 27/09; H01S 3/00

(52) U.S. Cl. CPC G02B 27/1006; H01S 3/005; G02B 27/0911

(57) ABSTRACT

An optical arrangement converts laser beams from at least two laser light sources into a combination beam, which has a beam waist. The optical arrangement has: an optical beam guidance system having at least two separate optical channels for the laser beams, each of the optical channels having an optical terminator for exiting a respective channel output beam of the relevant one of the optical channels; and a deflecting body, which is associated with only one of the optical channels. The deflecting body is configured such that only the respective channel output beam of the associated one of the optical channels is captured and the captured channel output beam is deflected in a direction of a focus region.

### CROSS-REFERENCE TO PRIOR APPLICATIONS

This application is a continuation of International Patent No. PCT/EP2019/064582, filed on Jun. 5, 2019, and claims benefit to German Patent Application No. DE 10 2018 115 102.0, filed on Jun. 22, 2018. The entire disclosure of both application is hereby incorporated by reference herein.

### FIELD

The present invention describes an optical arrangement for converting laser beams from a plurality of laser light sources into a combination beam having a beam waist, and a laser system comprising such an optical arrangement.

### BACKGROUND

A possible, but not exclusive, field of application for an optical arrangement is in laser systems that are used to generate a useful light distribution having a linear beam profile. Such beam profiles are used, for example, in the machining of surfaces of semiconductors or glasses, for example in the production of thin-film transistor (TFT) displays, in the doping of semiconductors, in the production of solar cells, or in the production of aesthetically designed glass surfaces for building purposes. Here, the linear beam profile is scanned perpendicularly to the extension direction of the line over the surface to be machined. The radiation can trigger superficial transformation processes (recrystallization, melting, diffusion processes) and the desired machining results can be achieved.

In the case of the laser systems mentioned, the laser beams are transformed into the desired, linear useful light distribution by optical devices, which, in particular, reshape and/or homogenize the laser radiation. An optical arrangement for generating a linear useful light distribution from laser radiation is described, for example, in WO 2018/019374 A1.

Because high-intensity radiation and/or long, linear intensity distributions are usually desired for the machining processes mentioned, a plurality of laser light sources is often used to supply the desired useful light distribution.

In order to not have to provide the optical devices, effective for forming lines, separately for each laser light source, it is desirable to merge the laser beams of the various laser light sources and to bundle them into a combination beam, in particular to bundle them spatially. For example, WO 2018/019374 A1 describes an optical arrangement having a beam path folded through a plurality of mirrors and lenses, the laser beams from a plurality of laser light sources being combined by means of a converging mirror with simultaneous expansion of the resulting beam. DE 10 2008 027 229 B4 describes an apparatus for beam forming and bundling, in which groups of laser beams extend part of their path in separate optical channels and are combined by means of a telescopic optical system which acts on a plurality of beam groups. Such arrangements comprise optical elements, which simultaneously capture a plurality of separately extending laser beams and must accordingly have large entry apertures. This can be connected to optical errors (e.g. lens errors) and make it difficult to adjust or fine-tune individual beams to one another. In addition, large-format lens components can lead to higher costs and complex installation space requirements.

### SUMMARY

An embodiment of the present invention provides an optical arrangement that converts laser beams from at least two laser light sources into a combination beam, which has a beam waist. The optical arrangement has: an optical beam guidance system having at least two separate optical channels for the laser beams, each of the optical channels having an optical terminator for exiting a respective channel output beam of the relevant one of the optical channels; and a deflecting body, which is associated with only one of the optical channels. The deflecting body is configured such that only the respective channel output beam of the associated one of the optical channels is captured and the captured channel output beam is deflected in a direction of a focus region.

### BRIEF DESCRIPTION OF THE DRAWINGS

Embodiments of the present invention will be described in even greater detail below based on the exemplary figures. The present invention is not limited to the exemplary embodiments. All features described and/or illustrated herein can be used alone or combined in different combinations in embodiments of the present invention. The features and advantages of various embodiments of the present invention will become apparent by reading the following detailed description with reference to the attached drawings which illustrate the following:

FIG. 1 shows a schematic representation of a laser system for generating a linear useful light distribution in a plan view;

FIG. 2 shows a schematic representation of the laser system according to FIG. 1 in a side view;

FIG. 3 shows a schematic representation of an optical arrangement in a plan view;

FIG. 4 shows a schematic representation of a further optical arrangement in a plan view;

FIG. 5 shows a schematic representation of a further optical arrangement in a side view;

FIG. 6 shows a schematic representation of the optical arrangement according to FIG. 5 in a plan view;

FIG. 7 shows a schematic representation of a laser system having two groups each comprising two optical channels;

FIG. 8 shows a schematic representation of an optical arrangement having two optical channels; and

FIG. 9 shows a representation corresponding to FIG. 6 for an arrangement having two optical channels.

### DETAILED DESCRIPTION

Embodiments of the present invention make it possible for beams to be merged for a plurality of laser beams, which offers flexibility in adapting to installation space requirements and in optical adjustment.

These improvements are achieved, for example, by an optical arrangement according to an embodiment of the invention. The optical arrangement is an apparatus for converting laser beams from at least two laser light sources into a combination beam, i.e. a beam of light merged from the individual laser beams, in particular in the form of a bundle of spatially merged beams (combination beam bundle). The optical arrangement is designed such that the combination beam has a beam waist.

The optical arrangement comprises an optical beam guidance system, which is designed to provide at least two separate optical channels for the laser beams. To this extent, each laser beam extends in one of the at least two optical channels. Each optical channel comprises an optical terminating means through which a channel output beam of the relevant optical channel exits when the optical arrangement is operated with laser light sources.

A deflecting body is provided for at least one of the optical channels and associated with the relevant optical channel. The deflecting body is designed such that only the channel output beam of the associated optical channel is captured, and the channel output beams of the other optical channels are not captured by this deflecting body. The captured channel output beam is directed or deflected by the deflecting body in the direction of a focus region of the combination beam.

The laser beams from the plurality of laser light sources are thus guided in separate optical channels in the beam path in front of the beam waist. An optical channel is distinguished in particular by the fact that a light beam is guided in the optical channel so as to be spatially separated and/or optically separated from the other optical channels. An optical channel can comprise a plurality of optically effective components (lenses, diaphragms, mirrors, etc.). In particular, the optical terminating means forms the termination of each optical channel, which means is designed, for example, as a converging lens.

Guiding the laser beams into separate optical channels offers the advantage, inter alia, that the optically effective components of each optical channel only have to have a limited size, because only light in the relevant optical channel has to be captured by the component. In particular, depending on the embodiment, lenses having large dimensions are not needed and therefore construction space can be saved, and lens errors can be reduced. In addition, the beam properties of the various laser beams can be formed and fine-tuned independently of one another in the separate optical channels. The separate optical channels also result in improved scalability of the overall structure. Additional channels can be added without having to change the entire optical structure.

The beams exiting the various optical terminating means are merged by means of the at least one deflecting body to form the beam waist of the combination beam. In this respect, the light distribution in this beam waist is supplied by a plurality of laser light sources. The beam waist is defined as the region in which the combination beam has the smallest beam cross section, i.e. the narrowest point of the combination beam.

The deflecting bodies are designed, in particular, such that the direction of propagation of the light in front of the deflecting body deviates from the direction of propagation after the deflecting body. In this respect, a bundle that converges in the beam waist is generated from the various channel output beams by means of the deflecting bodies. The deflecting bodies are preferably used to influence the direction of propagation. The laser beams, which are spaced apart from one another, can be merged without large-format lenses. As a result, the problems outlined at the beginning can be reduced.

With the arrangement described, it is also possible to change the position, alignment and/or design of the individual deflecting bodies, and thus; to adjust the properties of the combination beam, in particular in the beam waist. In this respect, an effective divergence angle for the combination beam after the beam waist can be specified by means of the position, alignment, and/or design of the deflecting bodies.

In the present context, a beam (light beam, laser beam, channel output beam, . . . ) does not designate an idealized beam in the sense of geometrical optics, but rather a real light beam which, for physical reasons, always has a finite extent in cross section. In the case of a laser beam, for example, the intensity curve in the beam cross section is influenced by the laser modes involved in the laser light source.

The optical arrangement is preferably designed to merge a plurality (in particular >3) of laser beams from different laser light sources. In particular, the optical arrangement comprises a plurality (in particular >3) of optical channels. For example, the optical arrangement can be designed such that the laser beams extend next to one another in an input-side region of the optical beam guidance system, in particular extend so as to be grouped next to one another. The optical channels are each designed in particular so that only one laser light beam from a laser light source extends per channel.

In particular, either a deflecting body is associated with an optical channel or the channel output beam exiting the optical channel transfers directly into the beam waist of the combination beam.

A deflecting body is preferably associated with each optical channel. This is favorable in particular when the channel output beams of the various optical channels do not initially extend in the direction of the beam waist after passing through the relevant optical terminating means.

A simplified structure results, for example, from the fact that a deflecting body is only associated with an optical channel when the channel output beam, exiting through the relevant optical terminating means during operation of the arrangement, has a direction of propagation which initially does not point in the direction of the focus region. In this respect, a deflecting body is provided in particular only for the optical channels for which the beam waist is not in the direction of the exit direction of the channel output beam. The other channel output beams can be guided to the beam waist without a deflecting body.

In the present context, the direction of propagation of a beam (light beam, laser beam, channel output beam, . . . ) denotes the spatially averaged output direction, in particular in terms of the spatial average of the Poynting vector.

The optical beam guidance system is preferably designed such that the channel output beams exiting all the optical channels (or their optical terminating means) all have a direction of propagation, which is parallel to a main direction. The main direction forms in particular an optical axis of the optical beam guidance system. In this respect, the channel output beams initially exit the various optical channels in parallel with one another and are combined by the deflecting bodies to form the beam waist in the focus region.

However, it is also conceivable that the channel output beams extend in different directions immediately after exiting the optical terminating means. For example, the optical beam guidance system can be designed such that some or all of the channel output beams exiting the optical channels already have a directional component toward the focus region. This reduces the deflection required by the deflecting body.

The at least one deflecting body is preferably designed as an optical transmission system such that the captured channel output beam is radiated into the deflecting body via a light entry surface and exits the deflecting body via a different light exit surface. The light entry surface is preferably oriented obliquely to the light exit surface. The light entry surface and the light exit surface themselves are preferably flat.

According to an advantageous embodiment, the deflecting body is formed in one piece from a material that is transparent to the laser beams. The material preferably has a refractive index >1 for the laser beams and therefore deflection takes place due to the refractive effect at the boundary surfaces of the deflecting body.

The deflecting body is advantageously designed such that a divergence angle or divergence spatial angle of the captured channel output beam is substantially unchanged before and after deflection by the deflecting body. In this respect, the deflecting body preferably is not used as a lens means for bundling and/or widening the beam, but rather is substantially only used to guide and deflect the relevant beam in the direction of the beam waist. The optical function for changing the divergence properties of the beam can be provided by the lens means of each of the optical channels, in particular by the optical terminating means. In such embodiments, any focusing, and necessary deflection is carried out by different optical components. This separation of the optical functions can simplify an adjustment of the optical arrangement.

In particular, it is conceivable that the at least one deflecting body is designed as an optical prism.

In a further embodiment, the optical arrangement has in particular a lens means, which is arranged in the beam path after the beam waist or in the beam waist. The lens means is designed in particular to shape the combination beam for being coupled into a subsequent beam transformation element. The lens means is preferably designed as a collimator lens, which is used to collimate or parallelize the combination beam after the beam waist. This prevents the combination beam from undesirably diverging again after the beam waist. The collimated bundle or telecentrically extending light bundle can then be further optically processed, for example in order to form a linear light distribution.

The collimator lens preferably has a focal plane or focal line at least on one side. The collimator lens can be arranged such that the focal plane or focal line extends through the focus region, i.e. through the beam waist. In this respect, the beam waist is preferably arranged on the object side of the focal length in relation to the collimator lens. The collimator lens is designed, for example, as a converging lens. In particular, the collimator lens forms the actual output aperture of the optical arrangement. The combination beam then exits, optionally after collimation, through this output aperture and can be processed further.

In a further embodiment, the optical beam guidance system comprises an anamorphic optical system for beam forming, in particular a telescope for beam forming, in at least some optical channels or in each optical channel, the optical terminating means of the optical channel being a component of the anamorphic optical system (in particular the telescope) in this optical channel. A telescope can in particular comprise two converging lenses which follow one another in the beam path and are arranged at a distance from their added focal lengths such that their mutually facing focal planes coincide (approximately in the manner of a Keppler telescope). The telescope is preferably designed as an anamorphic telescope in the at least one optical channel such that laser beams are anamorphically deformed in the relevant optical channel. In particular, the telescope is designed to bring about a cylindrical change in the image scale along an axis that is perpendicular to the direction of propagation of the laser beams in the optical channel.

The optical beam guidance system preferably comprises, in each optical channel, two anamorphic telescopes, which are arranged in series in the beam path and act with respect to two different directions of distortion (in particular with respect to two perpendicular directions). As a result, the beam properties can be adjusted with respect to two perpendicular axes.

The improvements set out at the beginning are also achieved by a laser system for generating a useful light distribution having a linear beam cross section. The laser system comprises at least two laser light sources for emitting laser beams. The laser system also comprises an optical arrangement of the type described above, wherein the optical arrangement is arranged such that the laser beams from the laser light sources are converted into the combination beam. The combination beam is processed further by means of an optical reshaping system following in the beam path and reshaped into the desired linear useful light distribution and optionally homogenized. The optical reshaping system is arranged in the beam path after the beam waist of the combination beam. A combination light beam supplied by a plurality of laser light sources is generated by means of the optical arrangement, which combination light beam is converted into the desired linear useful light distribution by the optical reshaping system. By adjusting the optical arrangement, in particular the deflecting body and/or the optical terminating means, the beam properties of the combination beam can be matched to the optical reshaping system.

The optical reshaping system is preferably arranged in the beam waist or in spatial proximity to the beam waist, optionally in the beam path after a collimation lens, as described above. The optical reshaping system can therefore be designed so as to have comparatively small spatial dimensions.

Further details and possible embodiments of the invention are described in more detail below with reference to the drawings.

In the following description and in the drawings, the same reference signs are used for identical or corresponding features.

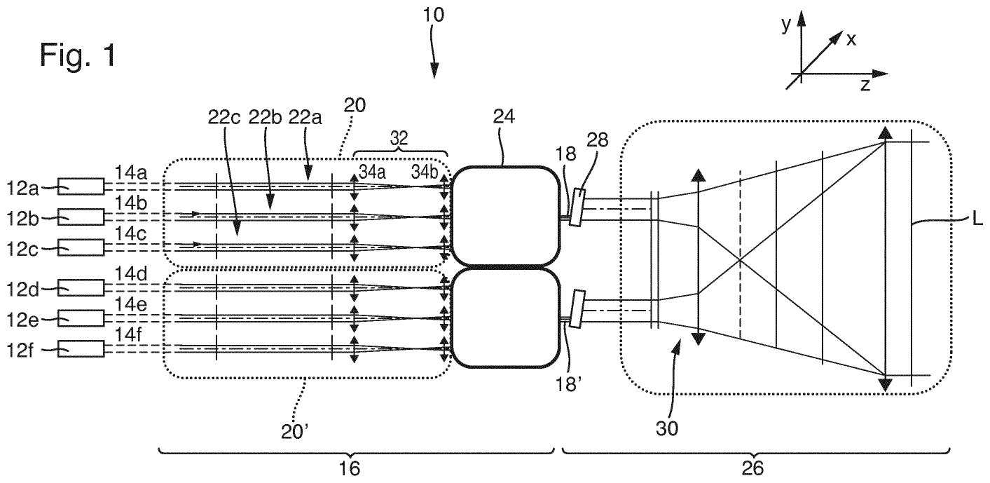

FIG. 1 shows a schematic representation of a laser system 10 for generating a useful light distribution (L) having a linear beam cross section.

In some figures, a right-handed Cartesian coordinate system is shown. Reference is made to the defined directions of the coordinate system in order to describe geometric relationships, without this being intended to be limiting for the arrangement and alignment of the apparatuses. In particular, individual units of the laser system 10 can have different orientations. In the example shown, the useful light distribution extends linearly in the X-Y plane in the Y direction.

The laser system 10 can comprise, for example, a plurality of laser light sources 12a to 12f for emitting respectively associated laser beams 14a to 14f. Of course, a laser light source which is suitable for emitting a plurality of laser beams (e.g. 14a to 14c or 14a to 14f) can also be used. In the example shown, the laser light sources 12a to 12f are arranged such that the laser beams 14a to 14f extend in two groups, each comprising three laser beams, in an input-side region of the laser system 10. For example, the laser beams 14a to 14f are arranged in a common plane (in the example shown in the Y-Z plane).

The laser beams 14a to 14f enter an optical arrangement 16, which is used to convert a plurality of laser beams (14a to 14c and 14d to 14f) into a combination beam 18 in each case. In the example shown, the optical arrangement 16 is designed such that a first group of laser beams 14a to 14c is merged into the combination beam 18, and a second group of laser beams 14d to 14f is merged into the combination beam 18′. For the further description, reference is made by way of example only to the first group of laser beams 14a to 14c and the optical components acting on them. The second group of laser beams 14d to 14f can be processed optically accordingly.

In the optical arrangement 16, the laser beams 14a to 14c initially extend in an optical beam guidance system 20, which provides separate optical channels 22a to 22c. In the example shown, a laser beam 14a to 14c extends in each optical channel 22a to 22c. The laser beams 14a to 14c, which are guided in the optical channels 22a to 22c transfer into an optical beam combining system 24 and are merged therein to form the combination beam 18.

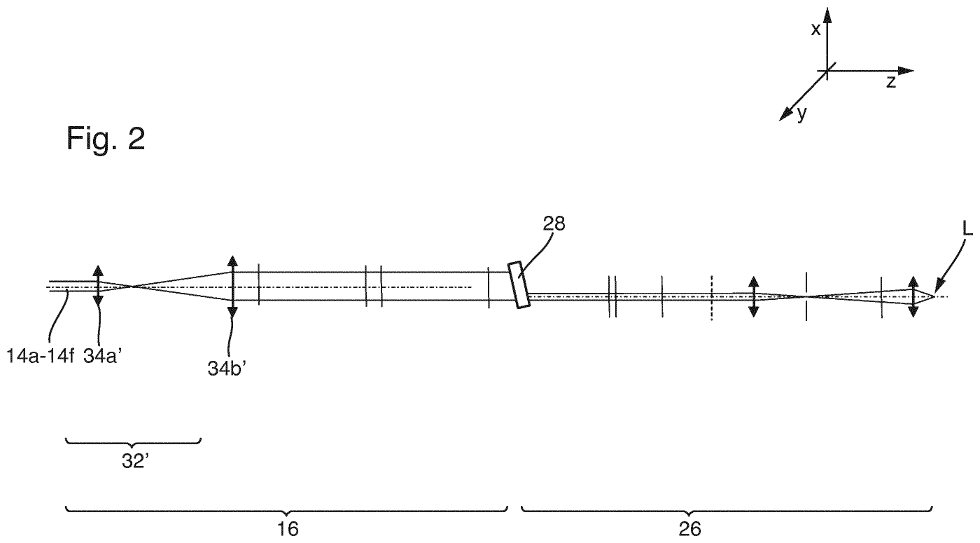

The combination beam 18 is then guided through an optical reshaping system 26, which reshapes the combination beam 18 into the desired linear useful light distribution L. Various embodiments are conceivable for the optical reshaping system 26. For example, the optical reshaping system 26 can comprise a beam transformation element 28, which initially changes the beam properties of the combination beam 18 anisotropically. In the example shown, the beam transformation element 28 increases the beam parameter product or the diffraction index M² of the combination beam 18 in the Y direction and reduces the beam parameter product or the diffraction index M² in the X direction (cf. FIG. 2).

The optical reshaping system can also comprise a homogenizer 30, shown in outline, which is designed to homogenize the intensity distribution in a preferred direction (for example the Y direction).

FIG. 2 shows the schematically illustrated laser system 10 according to FIG. 1 in a side view. In the example shown, the laser beams 14a to 14f all extend in one plane and are therefore one above the other in the view according to FIG. 2. A fundamental aspect of the invention can consist in the optical arrangement 16 merging and combining the laser beams 14a to 14f with respect to only one direction of action (in the example shown, the Y direction). In this respect, the optical arrangement 16 can in particular be designed such that the laser beams 14a to 14f remain substantially unaffected with respect to a direction perpendicular to the preferred direction (in the example shown, the X direction).

The optical beam guidance system 20 is preferably also designed to preform the laser beams 14a to 14c guided in the optical channels 22a to 22c. For example, at least one telescope 32, 32′ can be provided in at least one optical channel 22a to 22c for influencing the beam properties in the respective optical channels. Such a telescope 32, 32′ acts as an optical beam forming system, and can, in particular, be designed to change the beam cross section in the optical channel 14a to 14f. It is conceivable that the telescope has anamorphic optical properties. For example, an anamorphic telescope 32 can be provided in an optical channel 22a to 22c, which telescope influences the beam properties with respect to a first direction (in the example shown, the Y direction).

In addition, a further telescope 32′ can be provided, preceding or following in the beam path, which telescope changes the beam properties in a direction perpendicular thereto (in the example shown, the X-direction; see FIG. 2). Various embodiments are possible for the telescopes 32, 32′. For example, the telescopes 32, 32′ can be designed as a Galileo telescope or Kepler telescope. In particular, it is conceivable to design the telescopes 32, 32′ as an arrangement of at least two converging lenses 34a, 34b or 34a′, 34b′, the converging lenses being designed such that their focal planes coincide between them in the beam path.

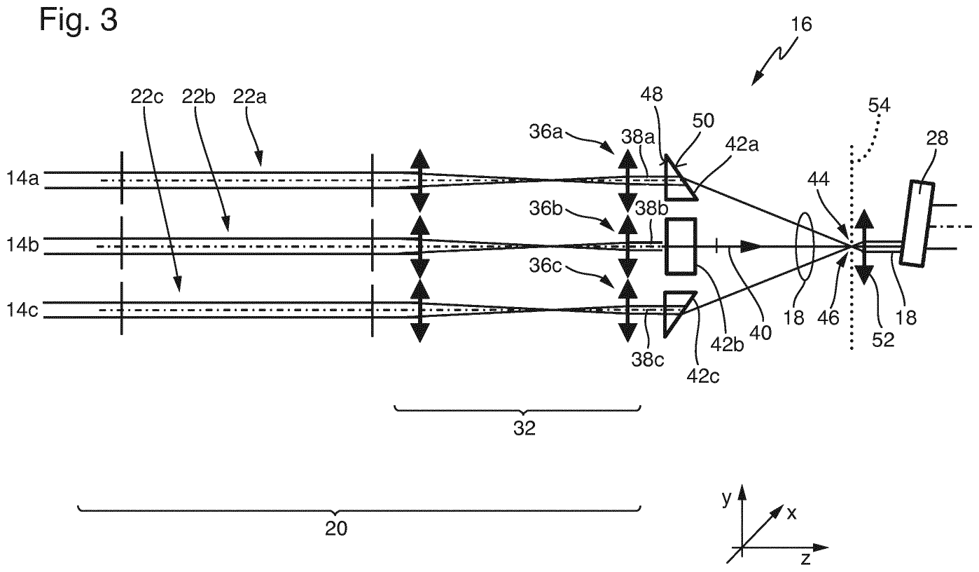

As can be seen in FIG. 3, the optical beam guidance system 20 has an optical terminating means 36a to 36c for each optical channel 22a to 22c. A separate optical terminating means 36a to 36c is preferably associated with each individual optical channel 22a to 22c. The laser radiation guided in the relevant optical channel 22a to 22c exits as an associated channel output beam 38a to 38c via the relevant optical terminating means 36a to 36c. In this respect, exactly one channel output beam 38a to 38c is associated with each individual optical channel 22a to 22c.

The optical terminating means 36a to 36c can advantageously be provided by a lens of a telescope 32 in the relevant optical channel 22a to 22c. Preferably, the output-side lens 34b of the relevant telescope 32 forms the optical terminating means 36a to 36c in the relevant optical channel 22a to 22c.

The optical beam guidance system 22 can be designed such that the channel output beams 38a to 38c initially all extend in a main direction 40 after exiting the relevant optical terminating means 36a to 36c (cf. FIG. 3). In particular, it is conceivable that the optical channels 22a to 22c are designed such that the channel output beams 38a to 38c are arranged symmetrically with respect to an optical axis (the optical axis extending in the main direction 40). In the example in FIG. 3, the channel output beams 38a to 38c extend in the Y-Z plane axially symmetrically to a central channel output beam 38b. In this respect, the middle channel output beam 38b extends in the main direction 40 on the optical axis of the system. However, such embodiments are not mandatory. It can also be advantageous that the channel output beams 38a to 38c extend partially obliquely to one another, in particular such that they form a converging light bundle.

The optical arrangement 16 also comprises a plurality of deflecting bodies 42a to 42c. Each deflecting body 42a to 42c is associated with one of the optical channels 22a to 22c. A relevant deflecting body 42a to 42c is dimensioned and arranged such that the deflecting body only captures the channel output beam 38a to 38c of each associated optical channel 22a to 22c. In particular, a relevant deflecting body 42a to 42c is arranged in the region of each associated optical terminating means 36a to 36c.

The deflecting bodies 42a to 42c are preferably designed as optical transmission systems, i.e. as optical bodies having a transmitting effect. However, it is also conceivable that the deflecting bodies 42a to 42c are each designed as an optical reflection system, in particular as a combination arrangement of mirrors. The deflecting bodies act on the respectively associated channel output beams 38a to 38c such that the channel output beam 38a to 38c captured by a deflecting body 42a to 42c is deflected to a focus region 44 of the optical arrangement 16 and a beam waist 46 of the combination beam 18 is formed there.

In particular, the relevant captured channel output beam 38a to 38c is deflected by refraction at the boundary surfaces of the deflecting body 42a to 42c. In particular, each deflecting body has a light entry surface 48 through which each captured channel output beam 38a to 38c is coupled into the relevant associated deflecting body 42a to 42c. The deflecting body 42a to 42c also has a light exit surface 50 through which the captured and coupled channel output beam 38a to 38c leaves the deflecting body 42a to 42c again and then has a directional component toward the focus region 44. This can be achieved in particular by the light exit surface being oriented obliquely with respect to the light entry surface.

In the example shown, the deflecting bodies 42a to 42c are designed as monolithic bodies in the form of optical prisms.

It can be advantageous if exactly one deflecting body 42a to 42c is associated with each optical channel 22a to 22c (cf. FIG. 3). This makes it possible to adjust the direction of propagation precisely for each channel output beam 38a to 38c and thus to influence the properties of the combination beam 18 in the beam waist 46.

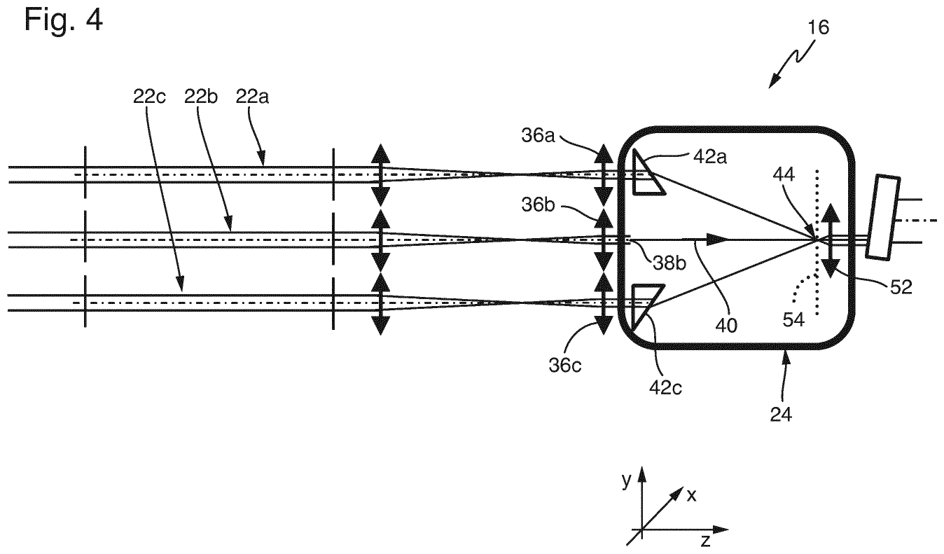

However, it can also be advantageous to provide deflecting bodies 42a to 42c only for the optical channels 22a to 22c for which the exiting channel output beam 38a to 38c does not propagate in the direction of the desired focus region 44. A corresponding embodiment is sketched by way of example in FIG. 4. The channel output beam 38b exiting through the optical terminating means 36b of the central optical channel 22b already extends on the optical axis of the system in the main direction 40 and is aimed at the focus region 44. In this respect, there is no need for deflection by a deflecting body. For the edge-side optical channels 36a and 36c, however, corresponding, associated deflecting bodies 42a and 42c are provided. This embodiment leads to a compact optical beam combining system 24.

In order to prepare the combination beam 18 for coupling into the following beam transformation element 28, the optical arrangement 16 can comprise a lens means 52. In particular, the lens means can be designed as a collimator lens 52, which is used to collimate the combination beam 18 and/or to parallelize it with respect to the main direction 40. The collimator lens 52 is preferably arranged in the beam path following the beam waist 46. The collimator lens 52 preferably captures the combination beam 18 completely and is, in this respect, coordinated in particular with the divergence angle in the region of the beam waist 46.

The collimator lens is preferably designed as a converging lens, which defines a focal plane 54. The collimator lens 52 is arranged in particular such that the focal plane 54 extends through the beam waist 46. As a result, it can be achieved that the combination beam 18 is parallelized after passing through the collimator lens 52 and, in this respect, enters a following beam transformation element 28 having a small divergence angle. It is also conceivable that the collimator lens is designed as a diffusing lens which is arranged in the beam path in front of the beam waist 46.

The channel output beams 38a to 38c can in principle also be deflected by means of a single cylindrical lens 56, which is arranged in the beam path following the optical terminating means 36a to 36c (cf. FIG. 6).

The cylindrical lens 56 acts in particular to bundle light in the plane in which the optical channels 22a, 22b, 22c are arranged next to one another. In this respect, the cylindrical lens 56 preferably has an axis, which extends perpendicularly to the plane in which the optical channels 22a to 22c extend next to one another.

The cylindrical lens 56 is preferably dimensioned such that all the channel output beams 38a to 38c are captured and are bundled by the focus region 44 and form a beam waist there. Such embodiments form a particularly simple optical beam combining system 24′, in which additional components to the cylindrical lens 56 can substantially be dispensed with (cf. FIG. 6).

In particular, when a cylindrical lens 56 having a large focal length is selected, the combination beam 18 has a small divergence angle in the region of the beam waist 46 and is then fed directly to a following beam transformation element 28.

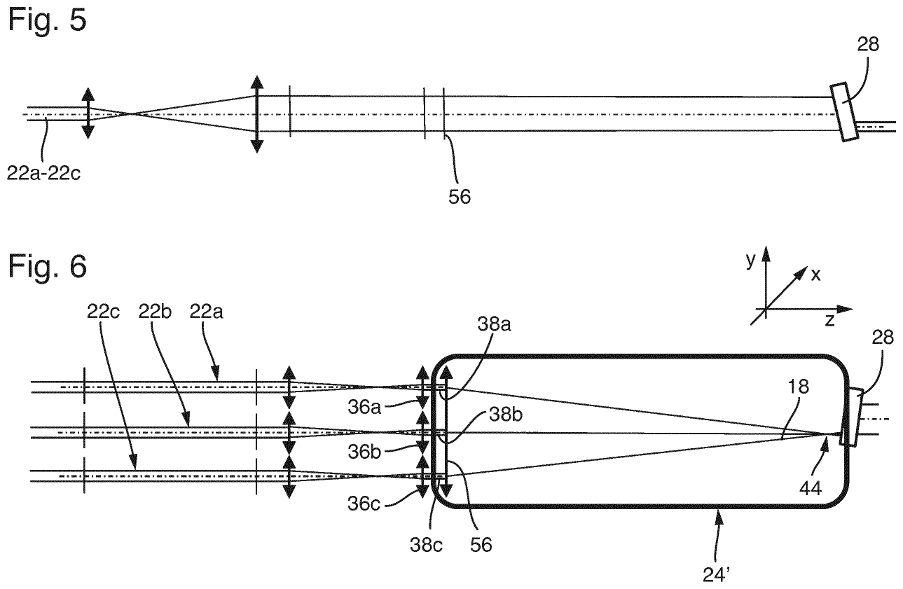

The optical beam combining system 24′ described in connection with FIG. 6 has an anamorphic effect and thus hardly influences the beam properties of the combination beam 18 in sections perpendicular to the beam combining plane (cf. FIG. 5).

FIGS. 1-6 show optical arrangements 16 which, by way of example, merge laser beams in three optical channels 22a to 22c to form the combination beam 18. This embodiment is not mandatory. In particular, the number of optical channels in the arrangement can be selected differently.

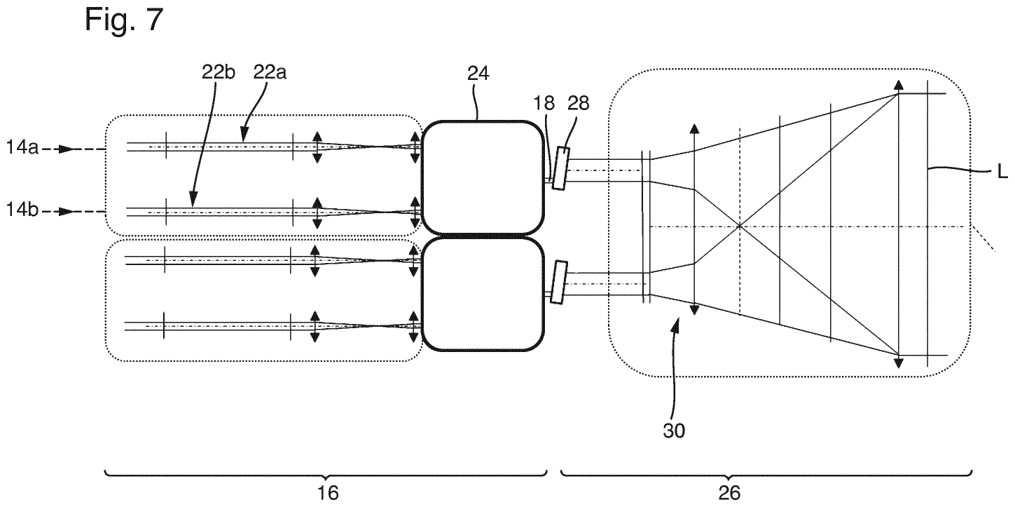

This is illustrated with reference to FIGS. 7-9, which each show an optical arrangement 16 which operates using two optical channels. The laser beams extend, for example, in two groups, each comprising two laser beams. For the purpose of illustration, only one group having the two laser beams 14a, 14b in the optical channels 22a, 22b is described.

Similarly to the embodiment in FIG. 1, the laser beams 14a and 14b in the optical arrangement 16 initially extend in an optical beam guidance system 20, which provides the two separate optical channels 22a, 22b. The laser beams 14a and 14b guided in the optical channels 22a and 22b transfer into the optical beam combining system 24 and are combined therein to form the combination beam 18. The combination beam 18 is then in turn guided through a beam transformation element 28, which contributes to reshaping the combination beam 18 into the desired linear useful light distribution L.

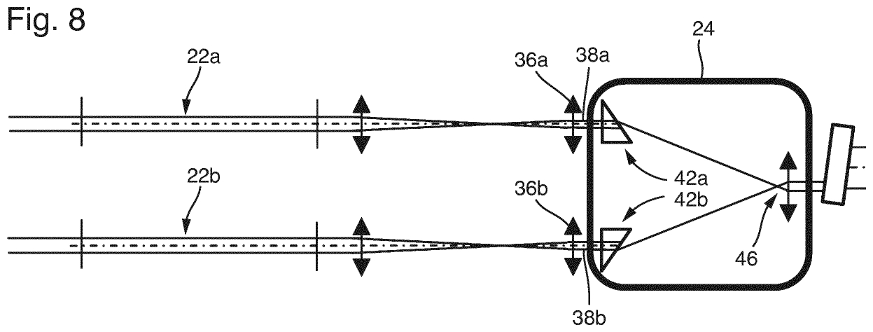

An associated channel output beam 38a or 38b exits through the optical terminating means 36a or 36b of the relevant optical channel 22a or 22b (cf. FIG. 8). In the example shown, a deflecting body 42a or 42b is associated with each optical channel 22a or 22b such that the channel output beams are merged to form the beam waist 46 in the manner described.

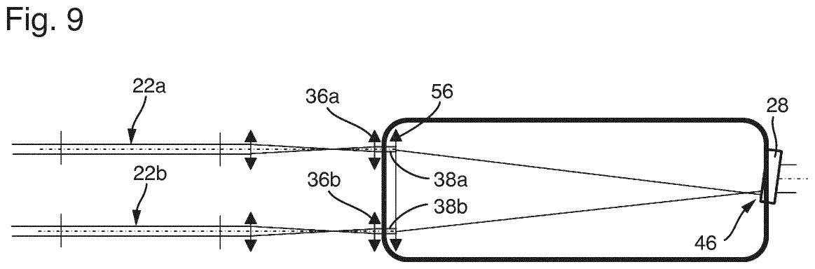

Deflecting the channel output beams 36a and 36b by means of a cylindrical lens 56 for the case of an arrangement having two optical channels 22a and 22b is shown in FIG. 9. The cylindrical lens 56 is arranged in the beam path following the optical terminating means 36a and 36b and captures the two optical channels 22a and 22b.

While embodiments of the invention have been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An optical arrangement for converting laser beams from at least two laser light sources into a combination beam which has a beam waist, the optical arrangement comprising:
an optical beam guidance system comprising at least two separate optical channels for the laser beams, wherein each of the optical channels comprises an optical terminator for exiting a respective channel output beam of the relevant one of the optical channels; and
a deflecting body, which is associated with only one of the optical channels, wherein the deflecting body is configured such that only the respective channel output beam of the associated one of the optical channels is captured and the captured channel output beam is deflected in a direction of a focus region.

2. The optical arrangement according to claim 1, wherein at most one deflecting body is associated with one of the optical channels.

3. The optical arrangement according to claim 1, wherein one deflecting body is provided for each of the optical channels, one of which comprising the deflecting body.

4. The optical arrangement according to claim 1, wherein the deflecting body is only associated with one of the optical channels when the channel output beam, exiting through the optical terminator of the associated one of the optical channels, has a direction of propagation which does not point in the direction of the focus region.

5. The optical arrangement according to claim 1, wherein the optical beam guidance system is configured such that the channel output beams exiting from the optical channels all have a direction of propagation which is parallel to a common main direction.

6. The optical arrangement according to claim 1, wherein the deflecting body is configured as an optical transmission system, wherein the captured channel output beam is radiated into the deflecting body via a light entry surface and exits from the deflecting body through a light exit surface.

7. The optical arrangement according to claim 6, wherein the light entry surface extends obliquely to the light exit surface.

8. The optical arrangement according to claim 1, wherein the deflecting body is monolithically formed from a material which is transparent to the laser beams.

9. The optical arrangement according to claim 1, wherein the deflecting body is configured such that the divergence of the captured channel output beam is unchanged before and after being deflected by the deflecting body.

10. The optical arrangement according to claim 1, wherein the deflecting body is designed as an optical prism.

11. The optical arrangement according to claim 1, wherein the deflecting body is designed as an optical reflection system.

12. The optical arrangement according to claim 1, the optical arrangement comprising a lens arranged in the beam path following the beam waist or in the beam waist.

13. The optical arrangement according to claim 12, wherein the lens is designed as a collimator lens which has a focal plane or focal line at least on one side, and wherein the collimator lens is arranged such that the focal plane or focal line extends through the focus region.

14. The optical arrangement according to claim 1, wherein the optical beam guidance system in each of the optical channels comprises a telescope for beam forming, and wherein the optical terminator is a component of the telescope in each of the optical channels.

15. The optical arrangement according to claim 14, wherein the telescope is designed as an anamorphic telescope.

16. A laser system for generating a useful light distribution which has a linear beam cross section, the laser system comprising:
the at least two laser light sources, wherein each of the laser light sources is designed to emit at least one laser beam of the laser beams;
the optical arrangement according to claim 1, wherein the optical arrangement is arranged such that the laser beams of the laser light sources are converted into the combination beam;
an optical reshaper configured to form the linear intensity profile from the combination beam,
wherein the optical reshaping system is arranged in the beam path after the beam waist of the combination beam.
